(19) United States
(12) Patent Application Publication
(10) Pub. No.: US 2014/0375770 A1
(43) Pub. Date: Dec. 25, 2014

(54) METHOD AND APPARATUS FOR DETECTION OF FOREIGN OBJECT DEBRIS

(71) Applicant: SYSTÈMES PAVEMETRICS INC., Québec, Québec (CA)

(72) Inventors: Richard Habel, Quebec (CA); John Laurent, Saint-Augustin-de-Desmaures (CA); Jean-François Hébert, Quebec (CA); Mario Talbot, Quebec (CA)

(21) Appl. No.: 14/375,806

(22) PCT Filed: Aug. 28, 2013
(86) PCT No.: PCT/IB2013/058082

§ 371 Date: Jul. 31, 2014

Related U.S. Application Data
(60) Provisional application No. 61/695,454, filed on Aug. 31, 2012.

(51) Int. Cl. G01N 21/94; G01N 21/88; H04N 13/02

(52) U.S. Cl. CPC G01N 21/94; H04N 13/0275; G01N 21/8851; G01N 2021/945; G01N 2201/06113
USPC 348/46

(57) ABSTRACT

A method and a system for the detection of Foreign Object Debris (FOD) on a surface of a transport infrastructure are described. The method comprises receiving 3D profiles of the surface from at least one 3D laser sensor, the 3D laser sensor including a camera and a laser line projector, the 3D laser sensor being adapted to be displaced to scan the surface of the transport infrastructure and acquire 3D profiles of the surface; analyzing the 3D profiles using a parametric surface model to determine a surface model of the surface; identifying pixels of the 3D profiles located above the surface using the surface model; generating a set of potential FOD by applying a threshold on the pixels located above the surface model to identify a set of at least one protruding object; providing detection information about the potential FOD.

### TECHNICAL FIELD

The invention relates to vision systems for the automated inspection of transportation infrastructures and more particularly, to the detection of objects using 3D laser sensors.

### BACKGROUND OF THE ART

The term Foreign Object Debris, or FOD, is generally used to describe the loose bits and pieces that can be found on airport operating surfaces. It can also refer to any debris or article alien to an infrastructure which would potentially cause damage or degrade the required safety or performance characteristics of the infrastructure. Although typically useful in the context of the aviation industry, the detection of objects which are alien to a surface can be useful for other transportation infrastructures such as railways, roads, etc.

The Federal Aviation Administration (FAA) Advisory Circular (AC) 150/5220-24 indicates that “FOD can be generated from personnel, airport infrastructure (pavements, lights, and signs), the environment (wildlife, snow, ice) and the equipment operating on the airfield (aircraft, airport operations vehicles, maintenance equipment, fueling trucks, other aircraft servicing equipment, and construction equipment)”. Furthermore the AC notes that “FOD can be composed of any material and can be of any color and size”. Moreover, the Master's thesis of S. Graves entitled “Electro-Optical Sensor Evaluation of Airfield Pavement” indicates that “of these sources of FOD, pavement debris is one of the most prevalent”. Raveling, the wearing away of the pavement surface caused by the dislodging of aggregate particles and loss of asphalt binder, ultimately leads to a very rough and pitted surface with FOD.

Most of the time, debris are harmless. In some cases, they cause minor damage such as flat tires or nicked engine blades. In rare cases, they cause catastrophic failures. The crash of the Concorde in July 2000 was caused by FOD on the runway. FOD costs airlines large expenses in aircraft repairs, flight delays, plane changes and fuel inefficiencies. Furthermore, there are other costs that cannot be calculated like the loss of life and the suspicion of malpractice.

Traditional approaches to FOD detection involve the use of manual driving surveys wherein a single inspector, or a team of inspectors, drives an inspection vehicle down the center of the runway at speeds typically ranging from 80-100 km/h and visually scans the surface for FOD. However, research has shown that this approach misses upwards of 96% of FOD actually present on the runway.

Following the Concorde crash, automated scanning systems capable of detecting debris emerged. U.S. Pat. No. 8,022,841, U.S. Pat. No. 7,782,251, U.S. Pat. No. 7,982,661, U.S. Pat. No. 7,592,943 and patent application publications US 2009/0243881, US 2011/0063445 and WO 2006/109074 disclose several electro-optical and radar FOD detection systems. These systems seem capable of detecting FOD with a detection threshold of a few centimeters depending on the weather, lighting conditions, material, color, size and cross-section that the debris present to the detectors. It is acceptable for most FOD systems to emphasize detection of the larger debris as those pose a more significant safety risk. Nevertheless, data taken in an operational context shows that few FOD smaller than 1 cm are found on runways by current scanning methods. The Concorde was downed by FOD less than 5 mm in height.

Airports operating multiple crossing runways and taxiways may not be able to build permanent installations along each runway and may have minimal space in the safety areas adjacent to runways.

None of the currently available solutions are able to provide the required sensitivity to locate smaller debris and cover the entire infrastructure operational area (runways, taxiways and aprons) efficiently.

### SUMMARY

According to one broad aspect of the present invention, there is provided a method for the detection of Foreign Object Debris (FOD) on a surface of a transport infrastructure. The method comprises receiving 3D profiles of the surface from at least one 3D laser sensor, the 3D laser sensor including a camera and a laser line projector, the 3D laser sensor being adapted to be displaced to scan the surface of the transport infrastructure and acquire 3D profiles of the surface; analyzing the 3D profiles using a parametric surface model to determine a surface model of the surface; identifying pixels of the 3D profiles located above the surface using the surface model; generating a set of potential FOD by applying a threshold on the pixels located above the surface model to identify a set of at least one protruding object; providing detection information about the potential FOD.

In one embodiment, the method further comprises receiving known object data, the known object data being information about a previously known object and wherein the generating the set of potential FOD further includes eliminating the known object from the set of protruding objects using the known object data.

In one embodiment, the method further comprises receiving geographical data for the 3D profiles and extracting a location for the protruding object using the geographical data.

In one embodiment, the detection information includes the location.

In one embodiment, the method further comprises receiving known object data, the known object data being information about a previously known object and wherein the generating the set of potential FOD further includes eliminating the known object from the set of protruding objects using the known object data, the location of the protruding object and a known location of the known object.

In one embodiment, the method further comprises extracting at least one of a shape and a size of the protruding object from the 3D profiles.

In one embodiment, eliminating the known object includes using the shape and/or size of the protruding object.

In one embodiment, the method further comprises assigning a severity level to the potential FOD using the shape and/or size, the detection information including the severity level.

In one embodiment, the method further comprises triggering an alarm upon detection of the potential FOD, the alarm including an indication of the severity level.

In one embodiment, the method further comprises generating a surface condition assessment using the surface model and the 3D profiles, the surface condition assessment providing information about a surface condition of the surface.

In one embodiment, the threshold is determined based on at least one of size, height and shape requirements for the detection.

In one embodiment, analyzing the 3D profiles using the parametric surface model to determine the surface model includes considering at least one surface characteristic, the surface characteristic including rutting, surface texture, joint, faulting between concrete slabs, crack, longitudinal profile, slope, cross-fall, lane marking and in-pavement fixture.

In one embodiment, the method further comprises combining 3D profiles of each of a plurality of 3D laser sensors for the steps of analyzing and identifying.

According to another broad aspect of the present invention, there is provided a system for the detection of Foreign Object Debris (FOD) on a surface of a transport infrastructure. The system comprises a processor adapted for receiving 3D profiles of the surface from at least one 3D laser sensor, the 3D laser sensor including a camera and a laser line projector, the 3D laser sensor being adapted to be displaced to scan the surface of the transport infrastructure and acquire 3D profiles of the surface; analyzing the 3D profiles using a parametric surface model to determine a surface model of the surface; identifying pixels of the 3D profiles located above the surface using the surface model; generating a set of potential FOD by applying a threshold on the pixels located above the surface model to identify a set of at least one protruding object; and a FOD detection generator for providing detection information about the potential FOD.

In one embodiment, the processor is further adapted for receiving known object data, the known object data being information about a previously known object and wherein the processor is adapted for eliminating the known object from the set of protruding objects using the known object data for the generating the set of potential FOD.

In one embodiment, the processor is further adapted for receiving geographical data for the 3D profiles and extracting a location for the protruding object using the geographical data.

In one embodiment, the processor is further adapted for receiving known object data, the known object data being information about a previously known object and wherein the processor is adapted for eliminating the known object from the set of protruding objects using the known object data, the location of the protruding object and a known location of the known object for the generating the set of potential FOD.

In one embodiment, the detection information includes the location.

In one embodiment, the processor is adapted for extracting at least one of a shape and a size of the protruding object from the 3D profiles.

In one embodiment, eliminating the known object includes using the shape and/or size of the protruding object.

In one embodiment, the processor is further adapted for assigning a severity level to the potential FOD using the shape and/or size, the detection information including the severity level.

In one embodiment, the processor is further adapted for triggering an alarm upon detection of the potential FOD, the alarm including an indication of the severity level.

In one embodiment, the processor is further adapted for generating a surface condition assessment using the surface model and the 3D profiles, the surface condition assessment providing information about a surface condition of the surface.

In one embodiment, the threshold is determined based on at least one of size, height and shape requirements for the detection.

In one embodiment, analyzing the 3D profiles using the parametric surface model to determine the surface model includes considering at least one surface characteristic, the surface characteristic including rutting, surface texture, joint, faulting between concrete slabs, crack, longitudinal profile, slope, cross-fall, lane marking and in-pavement fixture.

In one embodiment, the processor is further adapted for combining 3D profiles of each of a plurality of 3D laser sensors for the steps of analyzing and identifying.

### BRIEF DESCRIPTION OF THE DRAWINGS

Having thus generally described the nature of the invention, reference will now be made to the accompanying drawings, showing by way of illustration example embodiments thereof and in which:

FIG. 1 includes FIG. 1A and FIG. 1B in which a vehicle provided with an example Laser Foreign Object Debris (LFOD) detection system is shown from a front perspective view (FIG. 1A) and a rear perspective view (FIG. 1B) in operation;

FIG. 2 shows an example trajectory for an inspection vehicle to cover a surface with a width larger than the detection field-of-view of the 3D laser sensors;

FIG. 3 includes FIG. 3A and FIG. 3B which are screen shots of a graphical user interface on which are shown a picture of the scene (FIG. 3A) and the results of the detection by the Laser Foreign Object Debris (LFOD) detection system (FIG. 3B);

FIG. 4 includes FIG. 4A, FIG. 4B and FIG. 4C which show a picture (FIG. 4A), a 3D image (FIG. 4B) and an image from a graphical user interface (FIG. 4C) on which detection results are shown for a set of keys planted on a surface to inspect;

FIG. 5 includes FIG. 5A, FIG. 5B and FIG. 5C which show a picture (FIG. 5A), a 3D image (FIG. 5B) and an image from a graphical user interface (FIG. 5C) on which detection results are shown for a wrench planted on a surface to inspect;

FIG. 6 is a range image showing a variety of FOD;

FIG. 7 shows an example 3D laser sensor casing;

FIG. 8 includes FIG. 8A and FIG. 8B in which are shown range data (FIG. 8A) and intensity data (FIG. 8B) obtained for a location on a surface to be inspected;

FIG. 9 includes FIG. 9A, FIG. 9B and FIG. 9C which show example graphical representations of the severity level: high severity (FIG. 9A), medium severity (FIG. 9B) and low severity (FIG. 9C);

FIG. 10 includes FIG. 10A, FIG. 10B and FIG. 10C which shows another example of a severity rating assigned to each detected FOD, the picture is shown in FIG. 10A, the intensity image is shown in FIG. 10B and the representation of the detections on a graphical user interface is shown in FIG. 10C;

FIG. 11 includes FIG. 11A and FIG. 11B which show two examples of aerial maps overlapped with data about detected FOD wherein a FOD with a high severity rating is shown in FIG. 11A and a FOD with a low severity rating is shown in FIG. 11B;

FIG. 12 is a flow chart of example steps of the method for detection of FOD; and

FIG. 13 is a block diagram of example components of the detection system.

It will be noted that throughout the appended drawings, like features are identified by like reference numerals.

### DETAILED DESCRIPTION

A Laser Foreign Object Debris (LFOD) detection system for reliably detecting objects that could degrade the required safety or performance characteristics of infrastructures is described hereinafter. The infrastructure can be a road, railway, race track, airport runway, taxiway, apron, tunnel lining, or any other surface. These objects will be referred to herein as Foreign Object Debris, or FOD. The LFOD system can detect FOD as small as a few millimeters under a variety of lighting conditions (daytime and night-time, surfaces lit by the sun or covered in shadows). The LFOD system can also assess the pavement condition in order to identify areas where pavement debris could eventually originate by detecting raveling. It can be used on various pavement types ranging from dark asphalt to concrete.

3D Laser Sensor

The LFOD system for the detection of Foreign Object Debris (FOD) on a surface of a transport infrastructure includes at least one 3D laser sensor to acquire high-resolution 3D profiles of the surface. Each 3D laser sensor has a camera and a laser line projector. Additional optical components, such as filters, are included as necessary. The laser line is projected onto the pavement surface and its image is captured by the camera.

The 3D laser sensors is adapted to be displaced to scan the surface of the transport infrastructure and acquire 3D transversal profiles of the surface at a plurality of longitudinal locations. For example, the 3D laser sensors can be provided on a vehicle which is adapted to circulate on or along the surface to be inspected. The translation mechanism which displaces the sensors to acquire the 3D profiles at a plurality of positions along the longitudinal direction can be a car or truck if the surface is a road but can also be any type of vehicle, man driven or robotized, such as a train wagon, a plane, a subway car, a displaceable robot, etc. The inspection vehicle on which are installed the 3D sensors can travel at speeds up to 100 km/hr.

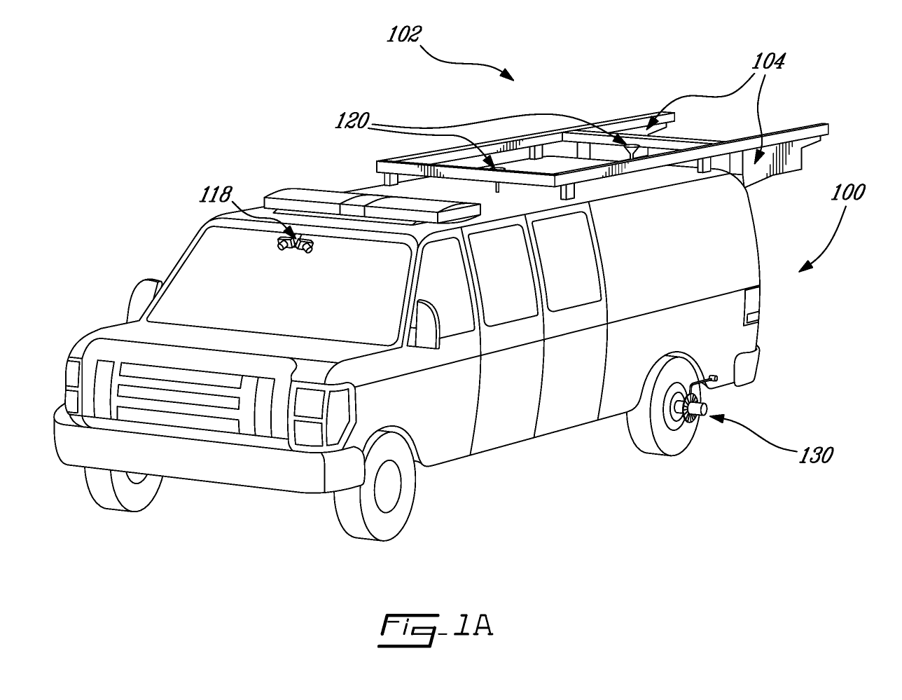

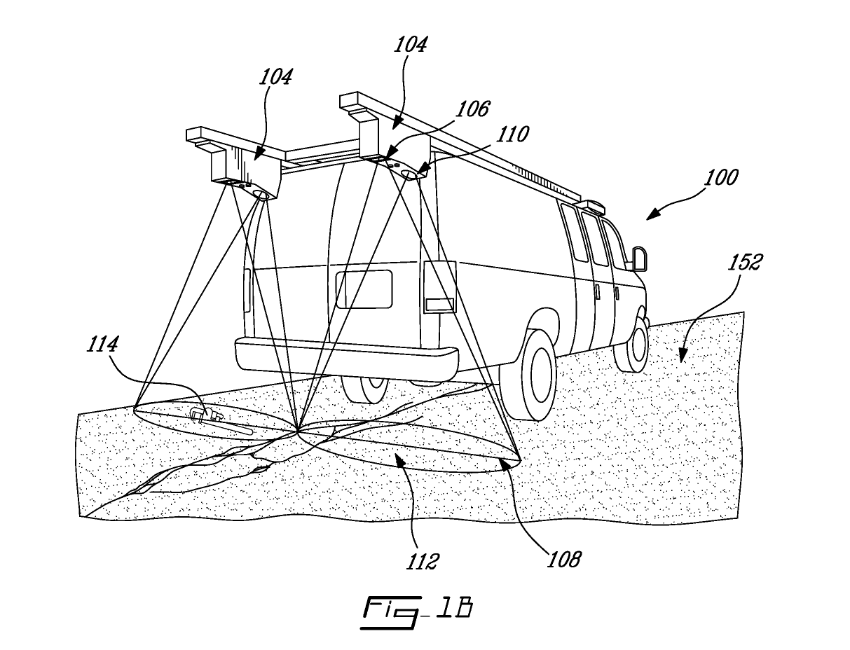

FIG. 1A shows an example vehicle 100 on which is provided the LFOD system 102. This vehicle 100 is adapted to travel, for example, on the runway, taxiway or apron of an airport or on a road. Two 3D laser sensors 104 are mounted on the vehicle and are oriented to scan the surface to be inspected 152.

The 3D laser sensor 104 has a field-of-view. The size of the field-of-view depends on the optics used in the 3D laser sensor and on the installation height and orientation of the 3D laser sensors. The field of view of an example installation of the 3D laser sensors 104 is shown in FIG. 1B. The laser line projector 106 projects a laser line 108 on the surface 152. The camera 110 captures the image of the laser line 108 in its field of detection 112. A FOD 114 is present on the surface.

The LFOD system can offer a modular approach as to the number of 3D laser sensors used in order to adapt to the various needs of infrastructure authorities. In one embodiment, two 3D laser sensors are provided and cooperate to produce the set of 3D profiles of the surface. The field-of-view of the 3D laser sensors can be made to overlap to ensure a continuous coverage of the detection zone.

For example, each pair of sensors can scan a transversal width of 4-6 m with a transversal resolution of 1-1.5 mm. If three pairs are used simultaneously, the total combined scanning width is 12-18 m. The 18 m width is advantageous since it ensures coverage of the critical landing gear footprint of the Boeing 747-8 Code F and Boeing 747-400 Code E.

In the example sensor installation shown in FIG. 1B, the 3D laser sensors 104 are installed at an installation height of 2.2 m. They are separated by a transversal distance of 2 m. Their combined field of view has a transversal width of 4 m.

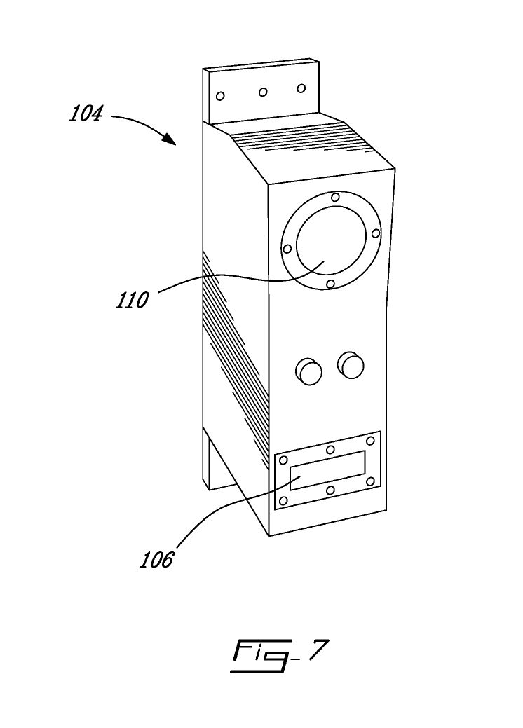

An example casing of the 3D laser sensor 104 is shown in FIG. 7. The example casing dimensions are 428 mm (h)×265 mm (l)×139 mm (w), its weight is 10 kg and its power consumption (max) is 300 W at 120/240 VAC.

In example embodiments, the 3D laser sensor has a sampling rate of 5,000 to 12,000 profiles/s, for example 11200 profiles/s. In some embodiments, 4096 3D points are acquired per profile. The vertical resolution is 0.5-1 mm. The depth range of operation can reach 250 mm.

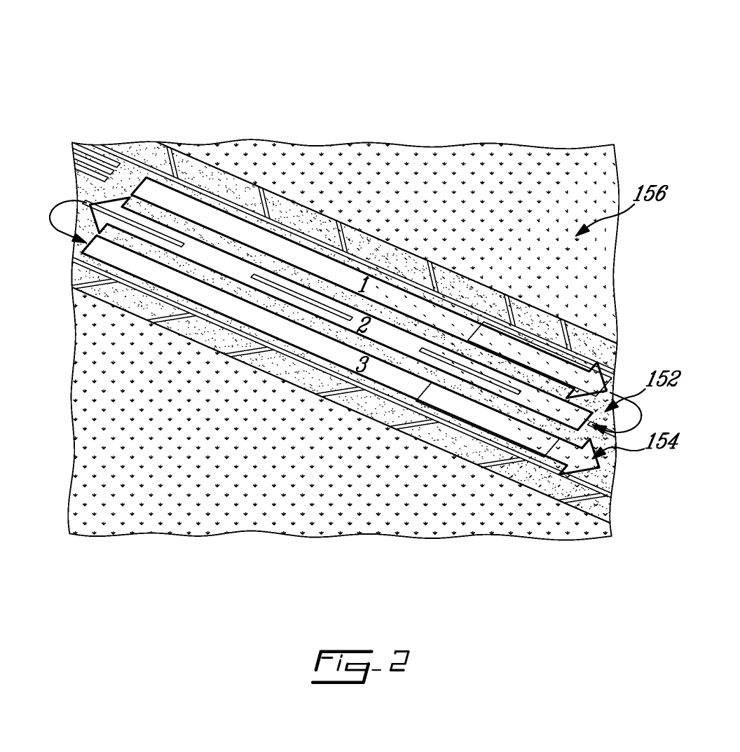

As shown in FIG. 2, if the surface to inspect 152 is larger than the width of the (individual or combined) field-of-view, the vehicle 100 can travel in a back-and-forth fashion 154 on the surface to inspect 152 to scan the whole area. Surrounding grounds 156 may be omitted from the inspection as per the specific requirements of the application.

As the inspection vehicle is being driven, the LFOD system 102 scans the surface. The 3D data scans are transferred to an onboard or remote processing computer. The connection between the laser sensors and the processor can be a high-speed network connection.

The 3D laser sensor therefore acquires a series of 3D profiles of a transversal section of the surface which are then cumulated and aggregated to recreate the longitudinal profile of the surface.

The LFOD captures range date. Optionally, intensity data can be acquired simultaneously. Relevant data on FOD which are detected to be present can be extracted from the 3D profiles. Examples of such relevant data include FOD location (linear reference and/or GPS coordinates), FOD height (max, min, average), FOD area, etc.

Intensity profiles provided by the LFOD are used to form a continuous image of the scanned surface. Intensity images can be used to identify the type of FOD present on the surface. Intensity images can also be used to detect highly reflective painted surfaces such as pavement striping and informational messages as such markings are highly contrasted compared to the surrounding pavement. A threshold operation can thus be applied to extract the location of the marking. With the proper pattern recognition algorithms, various markings can be identified and surveyed.

The intensity data can be transformed into an image in grey-scale. An intensity image is formed by the aggregation of a plurality of transversal intensity profiles along the longitudinal direction. If an intensity value of 0 is assigned to the color black and an intensity value of 255 is assigned to the color white, the intensity data can be represented in varying shades of grey. Alternatively, the intensity data can be obtained from a color or a black and white image obtained using an external camera or device or a range image.

The range data acquired by the LFOD system measures the distance from the sensor to the surface for every sampled point on the road. The range data, also referred to as 3D data, includes transversal, longitudinal and elevation information for each point in the 3D profile. A range image is formed by the aggregation of a plurality of transversal range profiles along the longitudinal direction. Elevation data can been converted to a gray scale. In range images, the lighter the point, the higher the surface is; so features above the surface (such as FOD) appear light grey or white in range images whereas features whose depth extends beneath the surface (such as cracks, raveling, rutting, potholes, etc.) appear as dark grey or black. FOD are sometimes readily visible on range images with the naked eye. However, FOD detection is actually performed using automated algorithms which analyze the 3D range data and apply minimum criteria for detection.

The range image can be combined with the intensity data to create a 3D image including the transverse position, the longitudinal position, the elevation and the intensity data for all acquired points. The 3D image is useful for reporting purposes since it provides a detailed graphical representation of the surface to inspect. The 3D image gives a sense of depth using the range data and ensures that the object is visible by using the intensity data.

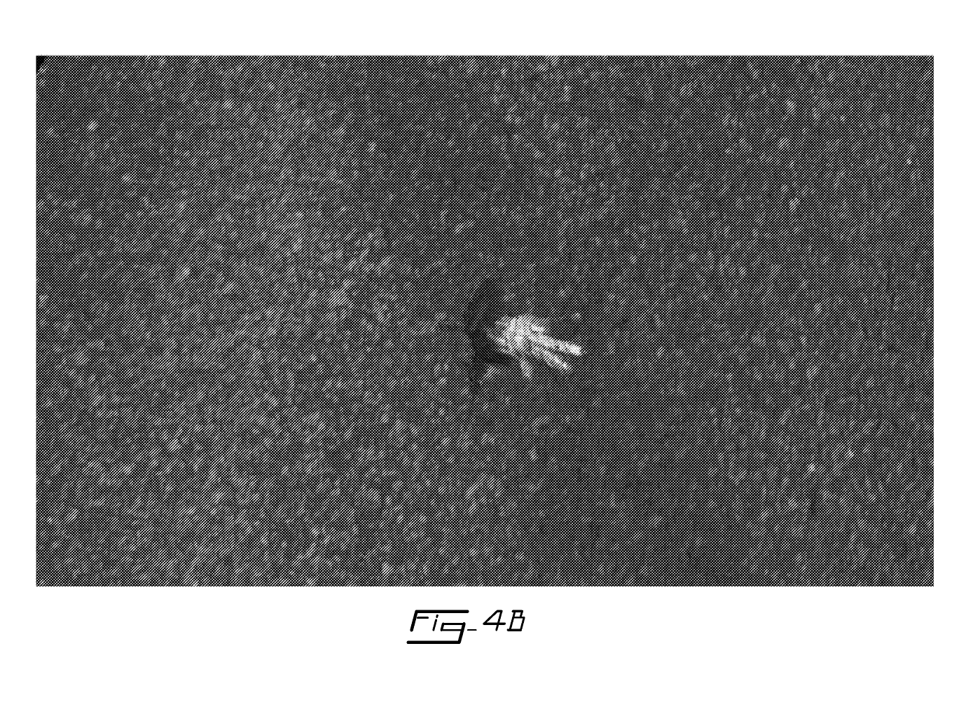

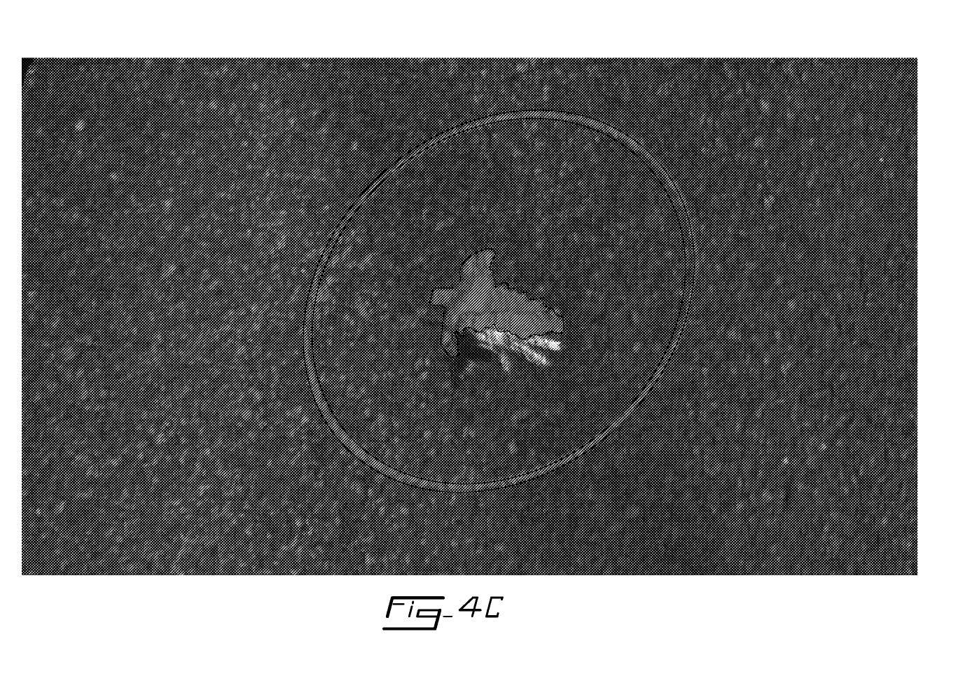

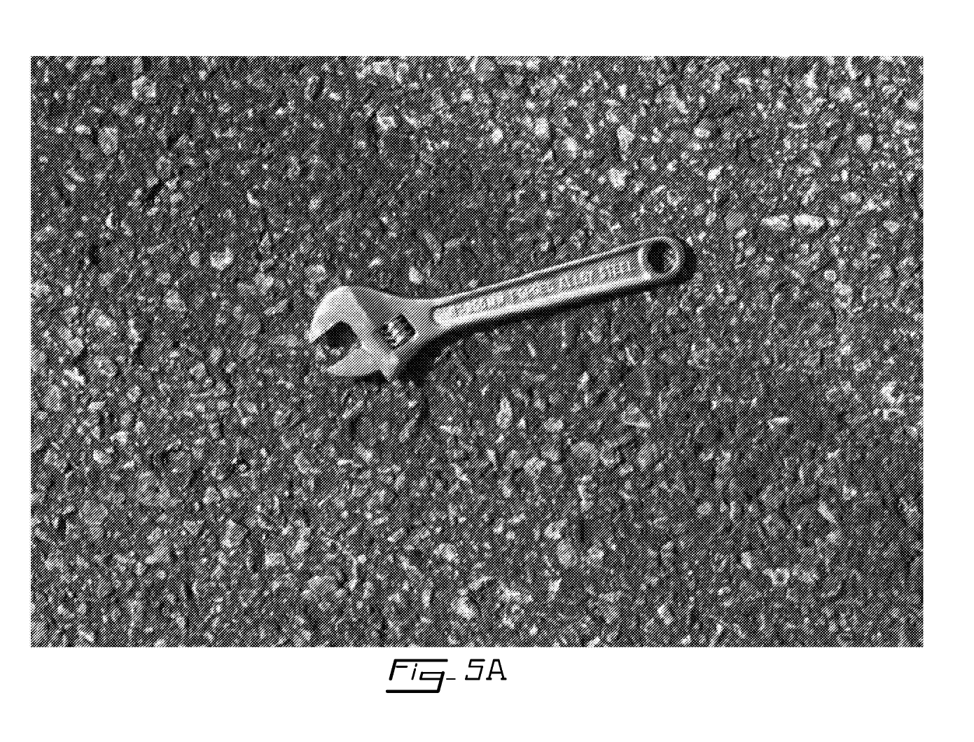

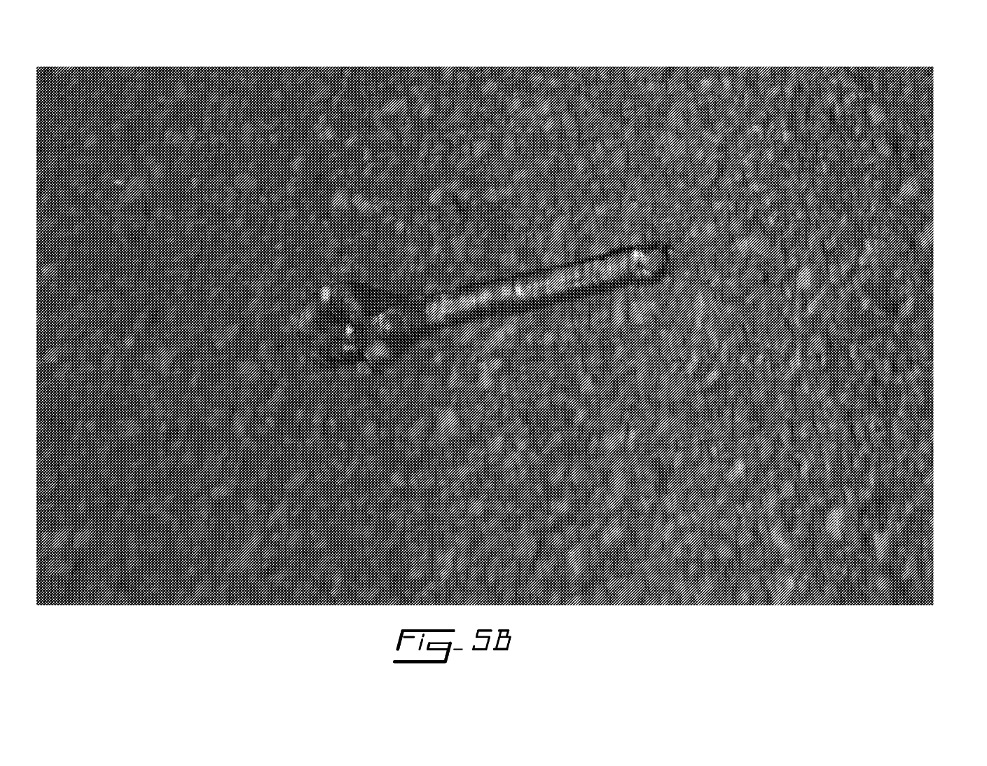

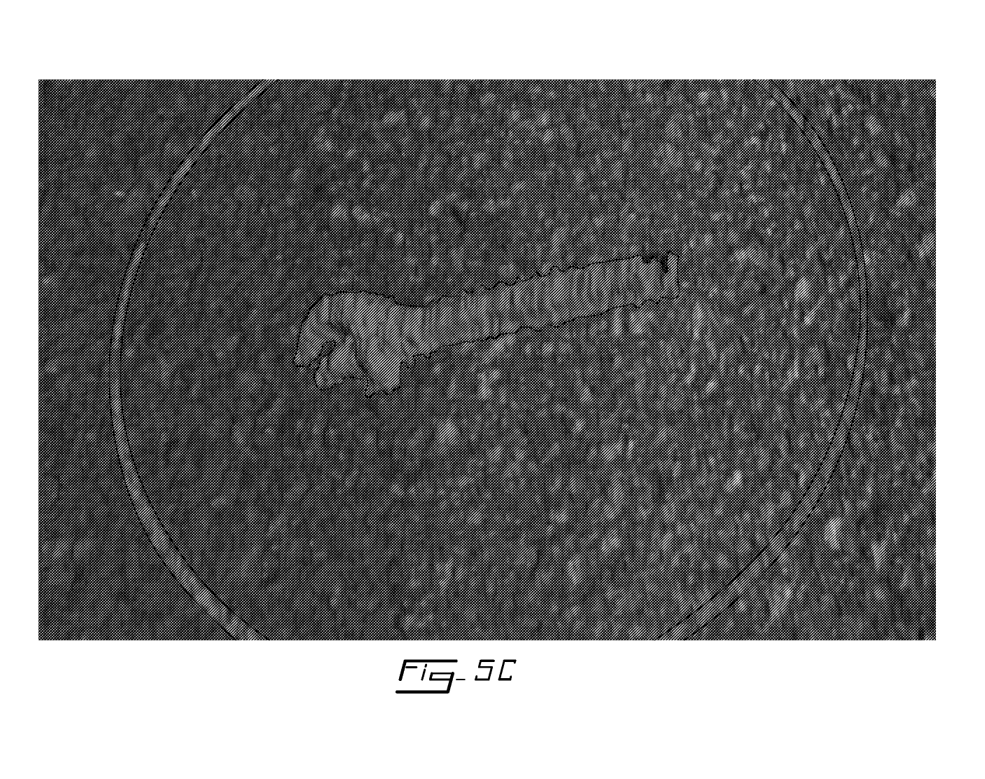

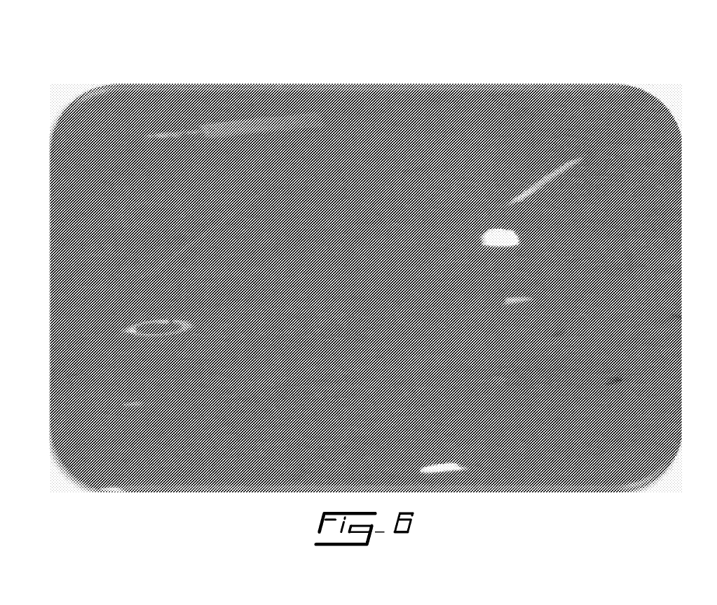

FIG. 4A and FIG. 5A show a picture of a FOD planted on a surface to inspect. In FIG. 4A, the FOD is a set of keys in a rut of the pavement surface. In FIG. 5A, the FOD is a wrench. As will be readily understood, the picture of FIGS. 4A and 5A is not required for the processor to carry out its detection of FOD. The picture may be useful for display to an operator but is superfluous in most cases. FIG. 4B and FIG. 5B show 3D images corresponding to the pictures of FIG. 4A and FIG. 5A. FIG. 6 is a range image showing a variety of FOD.

Optional Sensors

In one embodiment, the LFOD system also acquires pictures of the surface being profiled by the 3D laser sensors. The pictures can be captured by a standalone camera (not shown). Pictures from the cameras can be digitized by high-speed frame grabbers and compressed, for example to 1/40th of their raw size, using data compression algorithms, such as lossless data compression algorithms, to minimize data storage requirements.

In one embodiment, the LFOD system also has at least one right-of-way imaging camera 118 for acquiring images of the surface for visual inspection and detection of poor surface conditions such as excessive vegetation, excessive amounts of FOD, poor drainage, etc. which could impede the displacement of the 3D laser sensors. The right-of-way camera 118 can also be used to acquire pictures of the surface as discussed above.

In one embodiment, the LFOD system also has at least one geographical location sensor for acquiring geographical data for the 3D profiles. The geographical location sensor has at least one antenna 120. The geographical location sensor can be provided by a Global Navigation Satellite System (GNSS) such as GPS, GLONASS or Galileo.

In one embodiment, the LFOD system also has an optical encoder used as an odometer to synchronize sensor acquisition as the inspection vehicle 100 travels across the surface 152. An example of such an optical encoder is a Distance Measuring Interval Module (DMI) wheel encoder 130. The DMI can control image capture rates for the 3D laser sensors 104 and other cameras (104, 118 and others) and geographical data acquisition rates for the geographical location sensor 120.

Processor

In the processor, FOD detection algorithms scan the 3D profiles for presence of debris which exceed operator-specified thresholds for minimum height and area. Objects meeting the minimum height and area criteria are recorded as FOD and their position as well as height, area and an actual image of the object can be recorded for each detected FOD.

In other words, the processor is adapted for receiving the 3D profiles of the surface from the 3D laser sensor, analyzing the 3D profiles using a parametric surface model to determine a surface model of the surface, identifying pixels of the 3D profiles located above the surface using the surface model and generating a set of potential FOD by applying a threshold on the pixels located above the surface model to identify a set of at least one protruding object.

The range data is used to detect FOD. The intensity data is optionally used to filter the detection made using the range data and/or to prepare a clearer detection report for an operator.

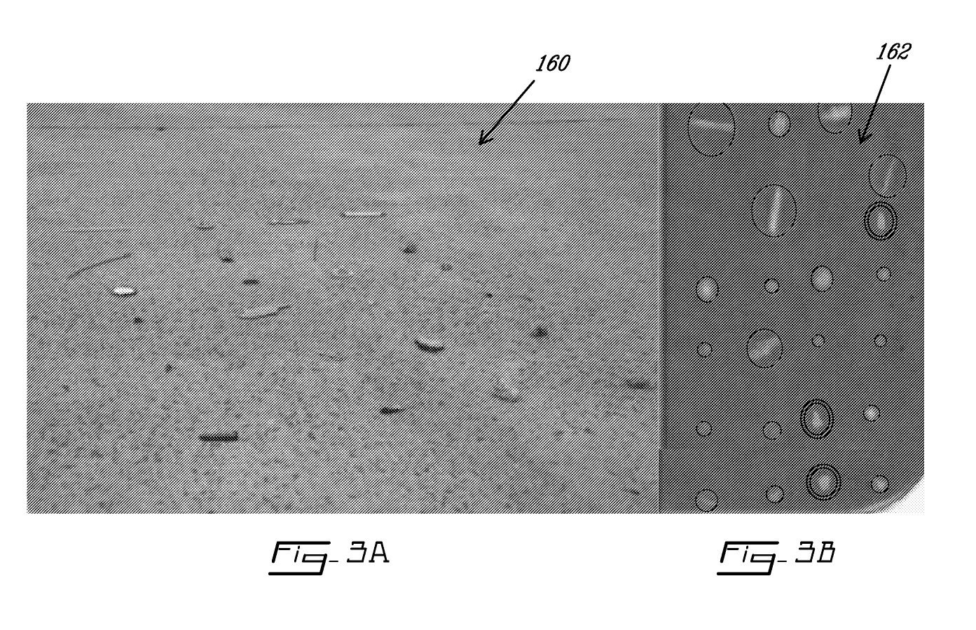

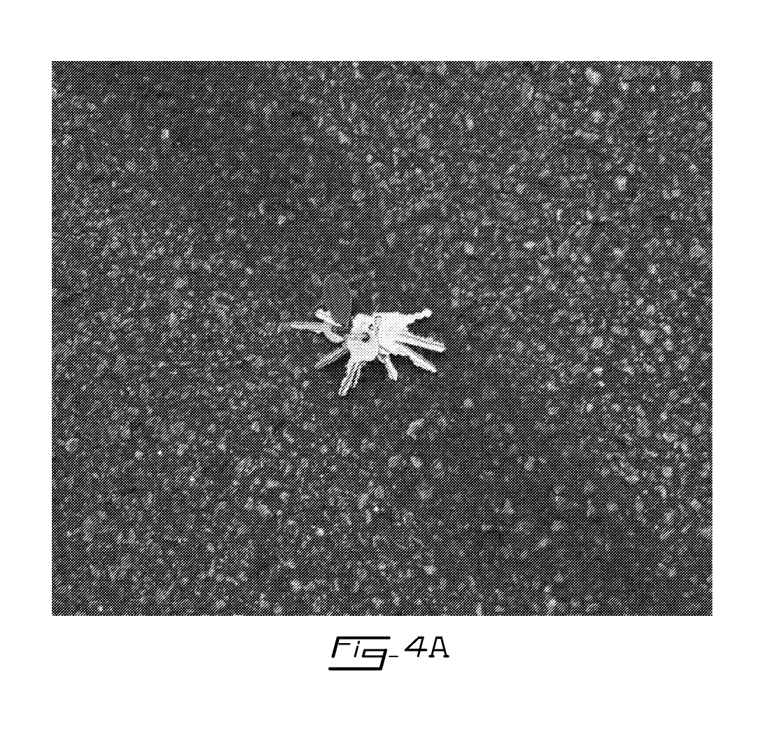

FIG. 3 shows example screen shots of a detection software interface where the results of the automatic FOD detection 162 are displayed to an operator (see FIG. 3B) together with a picture 160 of the scene (FIG. 3A). In the scene, a plurality of FOD having different textures, colors, heights, areas, durability and flexibility are present and can be seen on the picture 160. After automatic FOD detection, the system has identified the objects as being FOD and has graphically indicated the presence of a FOD on image 162 by coloring the pixels corresponding to the detected object and by circling the area in which the object is located. The detected object can be identified for display to an operator on either the intensity image, the range image or a 3D image combining the range data with the intensity image.

FIG. 4C shows a detected set of keys and FIG. 5C shows a detected wrench. The detected objects are identified on the 3D images of FIG. 4B and FIG. 5B respectively. As will be readily understood, the detected objects could be identified on a picture, a range image or an intensity image of the scene.

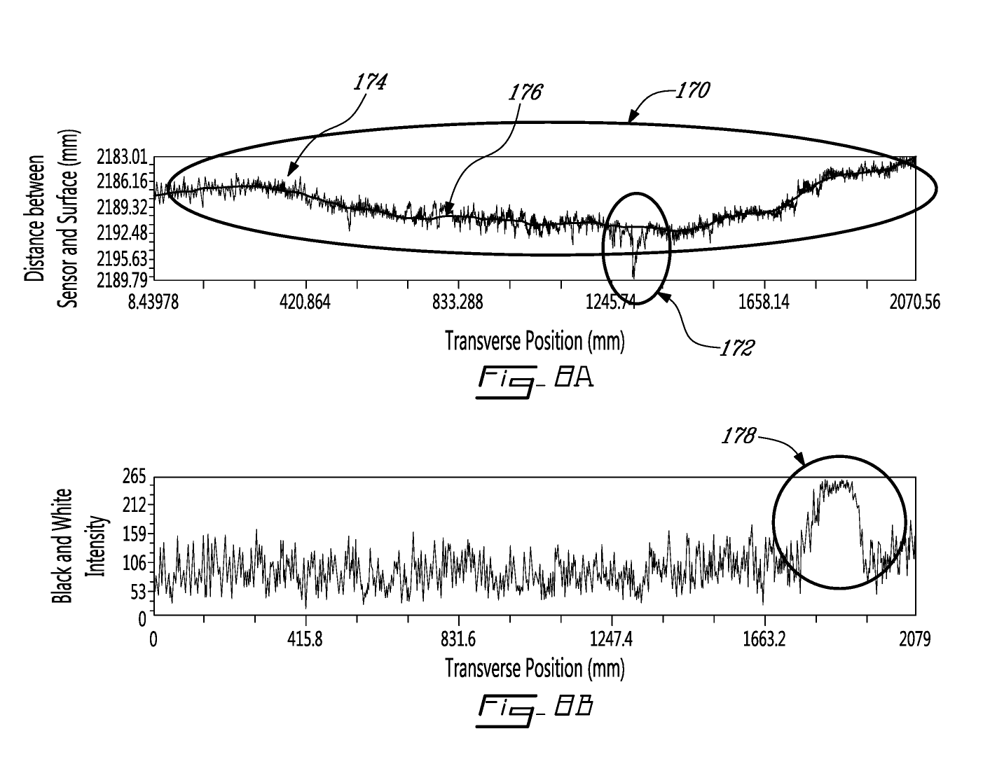

From a pavement condition inspection perspective, most features are located in the high-spatial frequency portion of the range data. FIG. 8A shows a 2 m-wide transverse range profile. The general depression of the range profile corresponds to the presence of a rut 170, the sharp drop in the center of the profile corresponds to a crack 172 and the height variations around the surface model line correspond to the macro-texture of the surface 174. The parametric surface model determines the surface model using the actual surface condition assessment. The parametric model is adapted to fit and track the 3D data to take into consideration active contour models, snakes and balloons, in order to delineate the surface 176 from the FOD to detect.

FIG. 8B shows a 2 m-wide transverse intensity profile. In the intensity profile, the rut, crack and macro-texture of the surface are not apparent. However, a marking 178 which has high reflectivity is apparent. This marking 178 was not apparent on the range profile of FIG. 8A because the layer of paint used to create the marking has negligible thickness. The detection of the marking from the intensity image can allow advanced filtering of the detections made by the processor using the range data (3D profiles).

The LFOD system can generate a surface condition assessment. Algorithms for the detection and quantification of a wide range of pavement distresses are available including: longitudinal profile, roughness, transverse profile, rutting, potholes, longitudinal cracking, transverse cracking, pattern cracking, joint seal failure, concrete slab faulting, macrotexture, bleeding, raveling. These data items can be used to support a full pavement management program for an airport's paved surfaces using MicroPAVER™ or other Pavement Management System software applications.

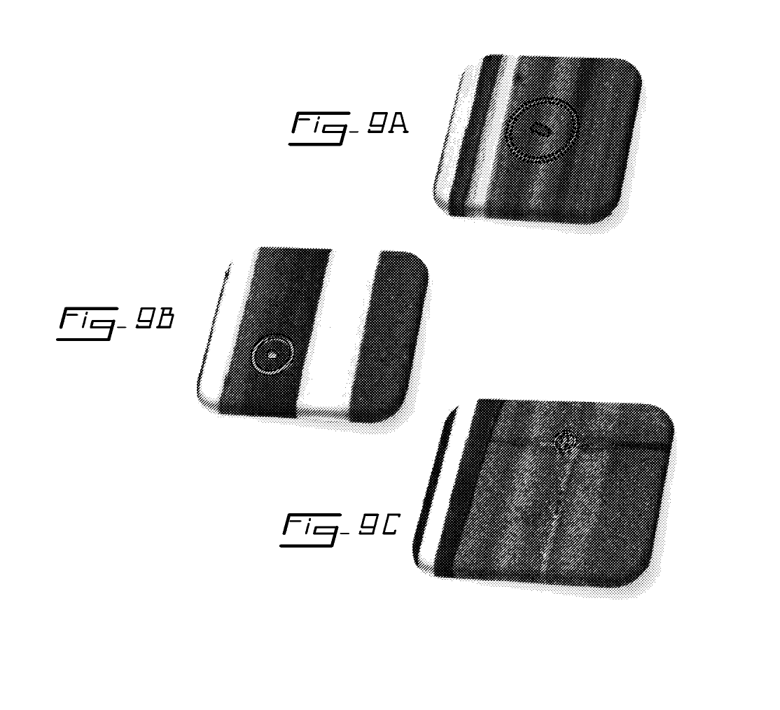

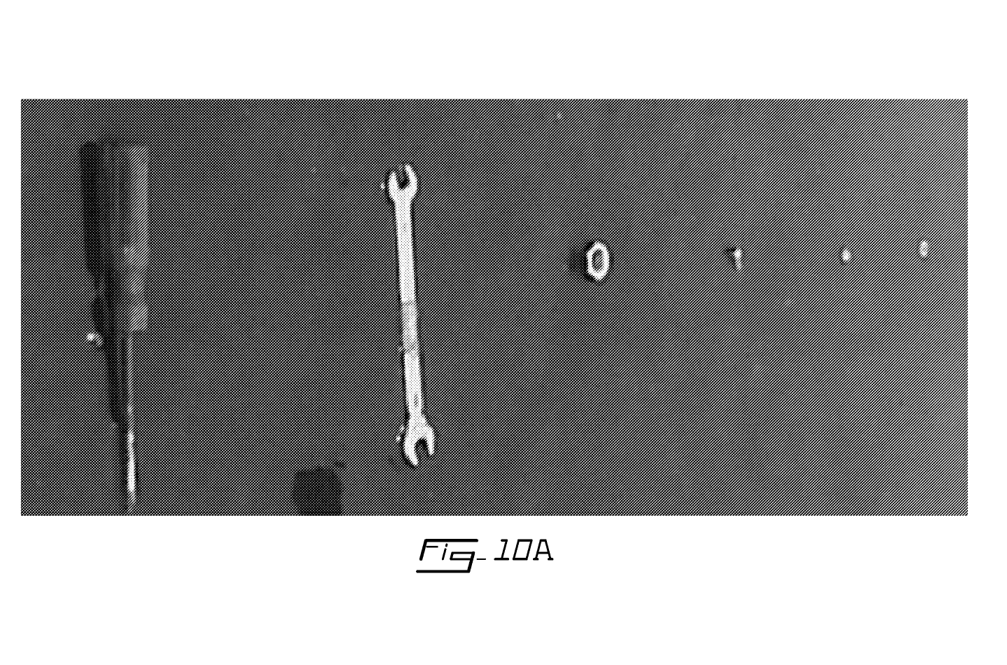

A severity rating can be given to each detected FOD based upon its height and area with the operator being able to configure the height and area ranges according to multiple levels of severity such as high, medium and low. An example graphical representation of the severity level is shown in FIG. 9. High severity FOD is marked in images using a red color (see FIG. 9A), medium severity is marked using an orange color (see FIG. 9B) and low severity FOD is marked using a green color (see FIG. 9C).

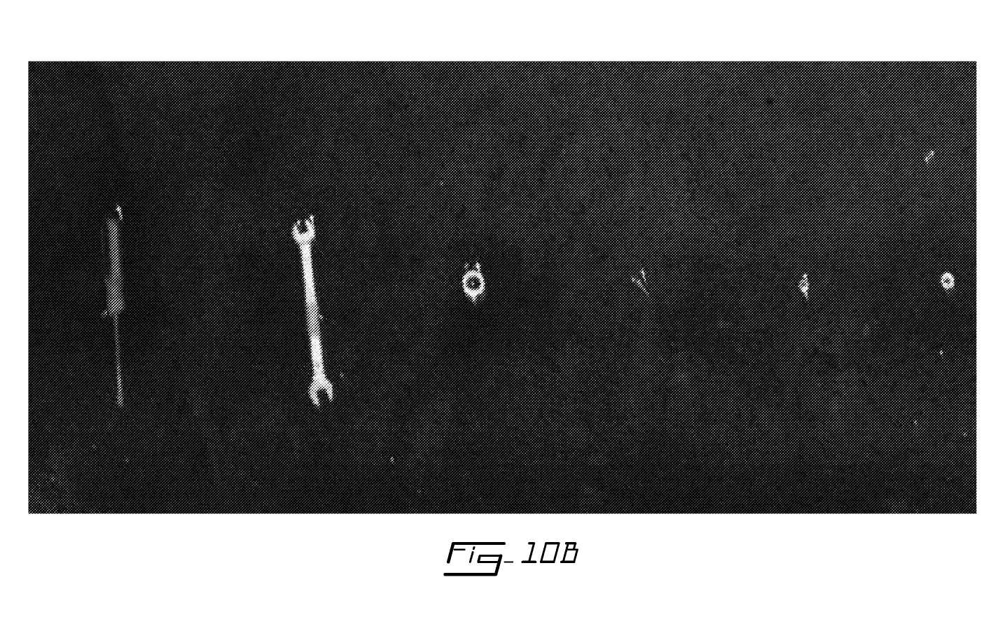

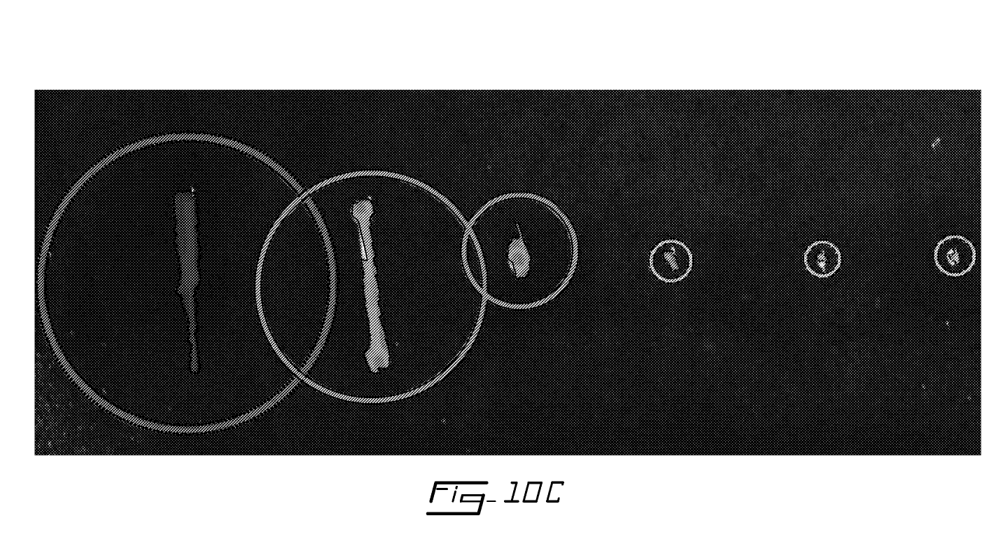

FIG. 10 shows another example of a severity rating assigned to each detected FOD for a detection of FOD in a water puddle. In FIG. 10A, the picture of the FOD is shown. In FIG. 10B, the intensity image is shown. Since most FOD in FIG. 10A are metallic, they reflect light are therefore appear very clearly on the intensity image of FIG. 10B, even if partly submerged in the water puddle. In FIG. 10C, the intensity image is superimposed with the detection markings (surrounding circle and colored object). Moreover, the severity rating color code detailed above is used to indicate which FOD present a higher risk.

As will be readily understood, the processing of the acquired 3D profiles to detect the FOD can be done in real-time, as the data is being acquired by the 3D laser sensor. Alternatively, the detection can be performed off-line, after acquisition has ended and data has been retrieved from the LFOD system.

It will be understood that the connection between the LFOD system and the processor which detects the FOD can be a wired or wireless connection. The processor can be provided as part or external to the LFOD system. Additionally, the communication between the processor and the LFOD system can be carried over a network. Processing of the data can be split in sub-actions carried out by a plurality of processors for example using cloud computing capabilities.

In an example embodiment, the thresholds listed in Table 1 are used by the processor:

TABLE 1
Example thresholds for the detection of FOD

| | |
|---|---|
| Minimum size FOD | Surface area between 1.5 cm² and 5.0 cm² |
| | Average height between 3 mm and 5 mm |
| Medium size FOD | Surface area between 5.0 cm² and 20 cm² |
| | Average height between 5 mm and 10 mm |
| Large size FOD | Surface area between 20 cm and 50 cm |
| | Average height greater than 10 mm |
| Extra large size FOD | Surface area greater than 50 cm |
| | Average height greater than 10 mm |

Known Fixtures Filter

In one embodiment, known object data containing information about a previously known object can be provided to the processor. The known object data can include height, area, shape and geographical location data about known objects, such as in-pavement fixtures. If the set of potential FOD includes a potential FOD whose characteristics correspond to one element of the known object data, the potential FOD can be identified as a known object and filtered out of the list of potential FOD. Example surface fixtures are a transition (drop-off, edge, curb), a rail, a rail tie, a lighting module, a drain port, a flag pole, a weather instrument, a sign, etc. Algorithms can be used to determine if a potential FOD is sufficiently similar to a known object in the known object database to be filtered out.

For example, if lighting fixtures are known to be circular and to have a certain diameter, the known fixtures filter may identify potential FOD objects having a circular or semi-circular shape and having a diameter corresponding to the diameter of the lighting fixtures (within an acceptable precision range) to be these known lighting fixtures. The potential FOD objects can then be discarded as being known. If the geographical location of the potential FOD object and of the known lighting fixtures are known, this additional information can further be used to discard the potential FOD as being known.

The detection of the marking from the intensity image can allow advanced filtering of the detections made by the processor. For example, objects detected at regular intervals on a marking can be excluded from the FOD list if it is known that lighting fixtures are present on the marking at regular intervals. However, should objects matching the shape of the lighting fixtures be detected outside of the marking, a detection of a displaced/errant lighting fixtures can be included on the FOD list.

Other filters can be implemented using correlation, template matching, neural networks, supervised classification, etc. to refine the identification of the FOD.

Report

A FOD detection generator is used for providing detection information about the potential FOD. This FOD detection generator can provide detection information to an operator via a graphical user interface or other user interaction module, such as a speaker adapted to produce an audible alarm. The FOD detection generator can also store the detection information in a database for future access by an operator.

If a graphical user interface is used, the system can indicate the presence of a FOD using a plurality of ways. In some embodiments, the presence of a FOD is shown on an image by coloring the pixels corresponding to the detected object and by circling the area in which the object is located. The detected object can be identified for display to an operator on either the intensity image, the range image or a 3D image combining the range data with the intensity data. Examples of such images prepared for display to an operator include FIG. 3B, FIG. 4C, FIG. 5C, FIG. 10C.

Alarms can be set by the operator to trigger only upon the detection of FOD of a minimum height and area. This is particularly useful considering the high sensitivity of the system and its ability to detect FOD down to a size of a few millimeters. The GPS coordinates, dimensions and images of small FOD which does not meet the airport-set criteria for immediate retrieval can be stored and used to create a targeted work program for weekly runway sweeping or vacuuming.

The advantage of performing the processing of the 3D profiles in real-time while the vehicle is carrying out the scan of the surface is that identified FOD can be readily collected by an operator seconds or minutes after the FOD has been detected. The inspection of the surface therefore guides the sweeping and/or vacuuming of the surface in real-time. The operator can travel onboard the inspection vehicle, can walk or run along the inspection trajectory or can travel in a separate vehicle which may be adapted for cleaning of the surface.

A number of different data elements are available as outputs from the system so as to allow the user to better manage their risk due to FOD. For each detected FOD the system can record the following: FOD location (linear as well as latitude, longitude and elevation), FOD height (max, min and average), FOD area or size, FOD shape, images of the FOD (range, intensity and 3D), FOD “severity rating” (High, Medium, Low). The system can also output data concerning the objects which did not meet the criteria to be identified as FOD but which were still identified by the system before being filtered out.

Data can be stored in an XML data format which can be readily imported into a variety of database and/or file formats such as Microsoft Access, Microsoft SQL, Oracle, Microsoft Excel, etc.

Over time, a database of detected FOD can be created documenting the date and time, location, shape, size and type of FOD detected at the airport. This information can serve as a valuable input into an airport's Safety Management System.

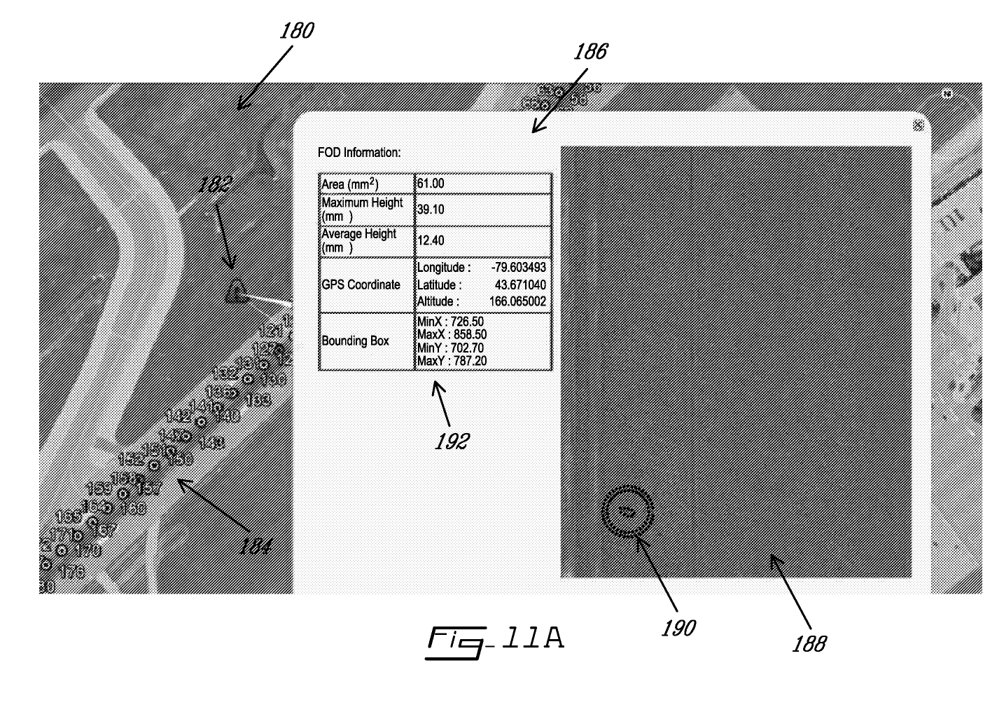

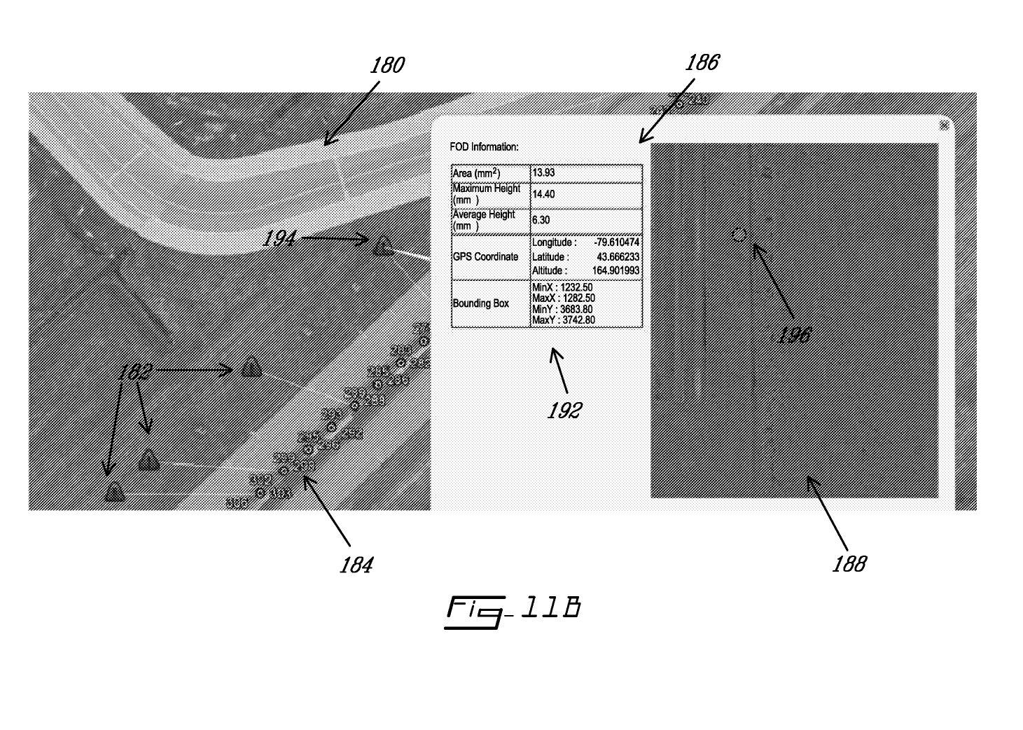

Additionally, a report can be generated using maps, such as Google Earth™ maps or high-definition transport infrastructure aerial maps, such that the locations of detected FOD are highlighted on a satellite or aerial photo along with a data file for each item detailing the FOD's key characteristics. FIG. 11 shows two examples of such maps overlapped with data about detected FOD.

In FIG. 11A, the FOD has a high severity rating. The aerial photo 180 bears an indicator 182 indicating where a FOD is located. Other markings 184 show where known fixtures are located. A data file 186 contains the intensity image 188 on which the FOD 190 is color coded (red) and circled for emphasis. A table 192 gives information about the FOD such as the FOD area (61 mm²), the maximum height of the FOD (39.10 mm), the average height of the FOD (12.40 mm), the GPS coordinates of the FOD including longitude, latitude and altitude and the bounding box data including the MinX, MaxX, MinY and MaxY data.

In FIG. 11B, the FOD 194 has a low severity rating. The aerial photo 180 bears indicators 182, 194 indicating where FOD are located. Other markings 184 show where known fixtures are located. A data file 186 contains the intensity image 188 on which the FOD 196 is color coded (green) and circled for emphasis. A table 192 gives information about the FOD such as the FOD area (13.93 mm²), the maximum height of the FOD (14.40 mm), the average height of the FOD (6.30 mm), the GPS coordinates of the FOD including longitude, latitude and altitude and the bounding box data including the MinX, MaxX, MinY and MaxY data.

Deployment

The LFOD system can be deployed in a number of ways depending on the operational needs of the user. During peak hours, when the time between take-offs and landings is at a minimum, the system can be operated in a single pass mode with the inspector following the same survey route as they normally would for a visual survey. In this way the inspector can concentrate on visually scanning the surface of the runway at its edges for the presence of FOD while the LFOD scans the middle portion of the runway using its high-speed lasers and automated algorithms.

During off-hours (e.g., at night-time during no fly times), the LFOD can be used to quickly perform a detailed FOD survey that would be practically impossible to perform using visual methods due to lighting conditions. In these situations the inspector can scan the runway surface using just a few passes to ensure 100% coverage at 1 mm scanning resolution.

Flow Chart

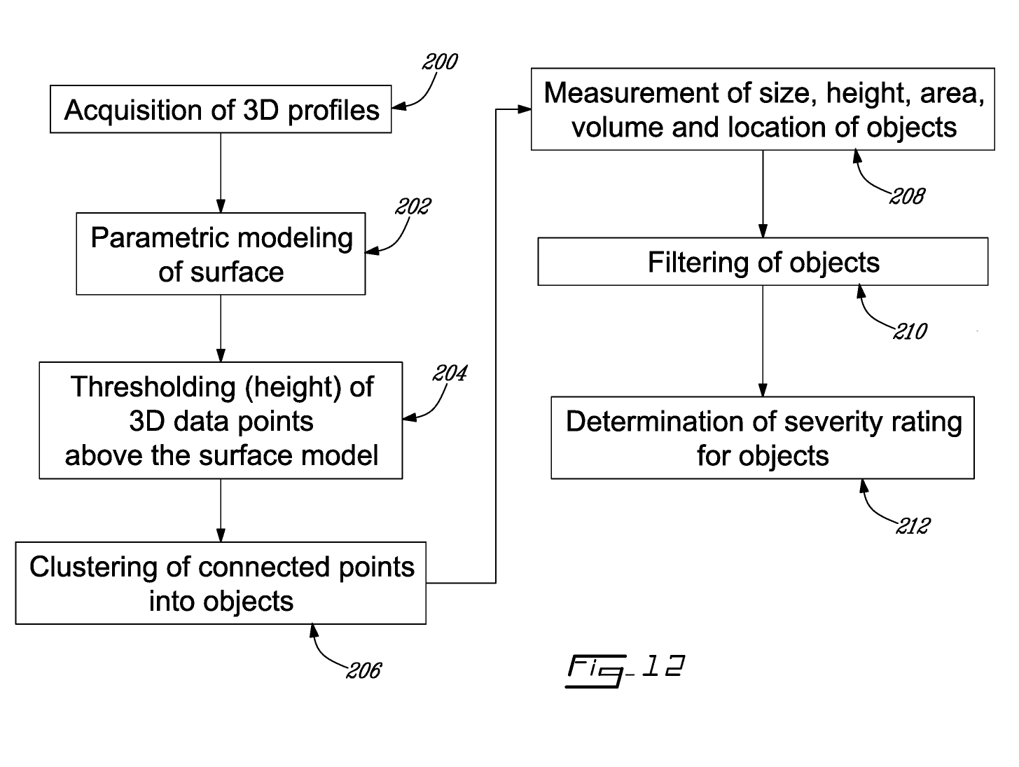

FIG. 12 is a flow chart of example steps of the method for detection of FOD. The first step is the acquisition of 3D profiles 200. The parametric modeling of the surface is then carried out 202. This yields a model of the surface which follows its characteristics and takes into account transversal and longitudinal features of the surface itself. It allows to determine the height of the modeled surface at all points.

Next, the thresholding of the 3D data points above the surface model 204 is carried out. This thresholding is done on the height of the 3D data points. All data points below a threshold are no longer considered as belonging to a potential FOD. All data points above the threshold are kept as candidates who may belong to a potential FOD.

A clustering of connected points 206 is done to group the candidate points into objects using a proximity criteria. This yields an object list.

The measurement of size, height, area, volume, location, etc. of the clusters is determined 208 from the 3D profiles and information which may come for additional sensors such as a GPS. The object list is augmented with the object feature information.

Then, the objects on the object list are filtered 210. They can be filtered based on dimensional and size constraints pre-determined by the system operator and/or filtered using a known object list which give information about known objects including their characteristics and their location. Filtering the known objects may include matching locations of objects on the object list with locations for known objects and/or correlating the dimension or the shape characteristics.

The remaining objects are identified FOD. A severity rating may be assigned to the FOD 212 based on their location and/or dimension characteristics and can be added to the detection information about the FOD.

The FOD list with their features and optional severity rating can be stored and/or outputted for use by an operator. Optionally, the filtered out objects may also be stored and/or outputted.

Block Diagram

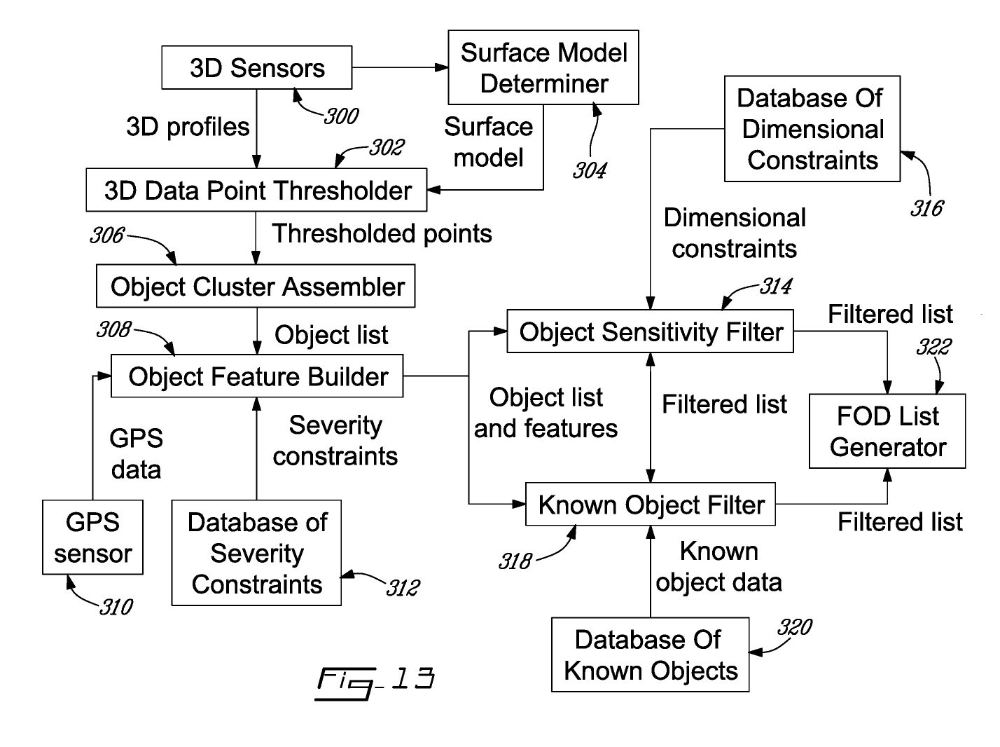

FIG. 13 is a block diagram of example components of the detection system.

3D sensors 300 acquire 3D profiles. The 3D profiles are transmitted to a processor which carries out data processing. The processor includes the following components. A surface model determiner 304 receives the 3D profiles and generates a surface model for the surface to be inspected. The surface model and the 3D profiles are transferred to a 3D data point thresholder 302 which outputs the thresholded points which are above the surface and which may belong to protruding objects. An object cluster assembler 306 assembles the neighboring thresholded points into object cluster and creates an object list. The object feature builder 308 uses data from the 3D profiles, from an optional GPS sensor 310 which provides GPS data and from a database of severity constraints 312 to generate features data for each object on the object list. The object list with the features is transmitted to the object sensitivity filter 314 and the known object filter 318. The object sensitivity filter 314 uses dimensional constraints obtained from a database of dimensional constraints 316 to filter out objects on the object list. For example, objects which are too small to be marked as FOD can be eliminated. The known object filter 318 receives known object data from the database of known objects 320 to filter out objects which are known to be present on the surface and which do not need to be reported as FOD. The filters can work in parallel or in series and may exchange their filtered lists. The known object filter 318 is optional and all objects with a size sufficient to be kept as a potential FOD could be identified as a FOD regardless of whether their presence is known. The filtered lists are provided to a FOD list generator 322 which can output of list of FOD with their relevant features.

The embodiments described above are intended to be exemplary only. The scope of the invention is therefore intended to be limited solely by the appended claims.

1. A method for the detection of Foreign Object Debris (FOD) on a surface of a transport infrastructure, comprising:
receiving 3D profiles of said surface from at least one 3D laser sensor, said 3D laser sensor including a camera and a laser line projector, said 3D laser sensor being adapted to be displaced to scan said surface of said transport infrastructure and acquire 3D profiles of said surface;
analyzing said 3D profiles using a parametric surface model to determine a surface model of said surface;
identifying pixels of said 3D profiles located above said surface using said surface model;
generating a set of potential FOD by applying a threshold on said pixels located above said surface model to identify a set of at least one protruding object;
providing detection information about said potential FOD.

2. The method as claimed in claim 1, further comprising receiving known object data, said known object data being information about a previously known object and wherein said generating said set of potential FOD further includes eliminating said known object from said set of protruding objects using said known object data.

3. The method as claimed in claim 1, further comprising receiving geographical data for said 3D profiles and extracting a location for said protruding object using said geographical data.

4. The method as claimed in claim 3, wherein said detection information includes said location.

5. The method as claimed in claim 2, further comprising receiving geographical data for said 3D profiles and extracting a location for said protruding object using said geographical data and receiving said known object data, said known object data being information about said previously known object and wherein said generating said set of potential FOD further includes eliminating said known object from said set of protruding objects using said known object data, said location of said protruding object and a known location of said known object.

6. The method as claimed in claim 1, further comprising extracting at least one of a shape and a size of said protruding object from said 3D profiles.

7. The method as claimed in claim 2, further comprising extracting at least one of a shape and a size of said protruding object from said 3D profiles, wherein said eliminating said known object includes using said at least one of said shape and said size of said protruding object.

8. The method as claimed in claim 5, further comprising assigning a severity level to said potential FOD using said at least one of said shape and said size, said detection information including said severity level.

9. The method as claimed in claim 8, further comprising triggering an alarm upon detection of said potential FOD, said alarm including an indication of said severity level.

10. The method as claimed in claim 1, further comprising generating a surface condition assessment using said surface model and said 3D profiles, said surface condition assessment providing information about a surface condition of said surface.

11. The method as claimed in claim 1, wherein said threshold is determined based on at least one of size, height and shape requirements for said detection.

12. The method as claimed in claim 1, wherein said analyzing said 3D profiles using said parametric surface model to determine said surface model includes considering at least one surface characteristic, said surface characteristic including rutting, surface texture, joint, faulting between concrete slabs, crack, longitudinal profile, slope, cross-fall, lane marking and in-pavement fixture.

13. The method as claimed in claim 1, further comprising combining 3D profiles of each of a plurality of 3D laser sensors for said steps of analyzing and identifying.

14. A system for the detection of Foreign Object Debris (FOD) on a surface of a transport infrastructure, comprising:
a processor adapted for
receiving 3D profiles of said surface from at least one 3D laser sensor, said 3D laser sensor including a camera and a laser line projector, said 3D laser sensor being adapted to be displaced to scan said surface of said transport infrastructure and acquire 3D profiles of said surface;
analyzing said 3D profiles using a parametric surface model to determine a surface model of said surface;
identifying pixels of said 3D profiles located above said surface using said surface model;
generating a set of potential FOD by applying a threshold on said pixels located above said surface model to identify a set of at least one protruding object; and
a FOD detection generator for providing detection information about said potential FOD.

15. The system as claimed in claim 14, wherein said processor is further adapted for receiving known object data, said known object data being information about a previously known object and wherein said processor is adapted for eliminating said known object from said set of protruding objects using said known object data for said generating said set of potential FOD.

16. The system as claimed in claim 15, wherein said processor is further adapted for receiving geographical data for said 3D profiles and extracting a location for said protruding object using said geographical data.

17. The system as claimed in claim 16, wherein said processor is further adapted for receiving said known object data, said known object data being information about said previously known object and wherein said processor is adapted for eliminating said known object from said set of protruding objects using said known object data, said location of said protruding object and a known location of said known object for said generating said set of potential FOD.

18. The system as claimed in claim 14, wherein said processor is further adapted for receiving geographical data for said 3D profiles and extracting a location for said protruding object using said geographical data.
